(19) United States
(12) Patent Application Publication
(10) Pub. No.: US 2003/0212919 A1
(43) Pub. Date: Nov. 13, 2003

(54) Updateable event forwarding discriminator incorporating a runtime modifiable filter

(76) Inventors: Ronald P. Adkins, Melbourne, FL (US); Francis St. Onge, Quebec (CA)

Correspondence Address: Robert J. Sacco, Akerman, Senterfitt & Eidson, P.A., P.O. Box 3188, West Palm Beach, FL, 33402-3188, US

(21) Appl. No.: 10/141,807

(22) Filed: May 9, 2002

(51) Int. Cl. H04L 1/22

(52) U.S. Cl. 714/4

(57) ABSTRACT

A method for updating an updateable event forwarding discriminator (UEFD) with a filter object. The filter object can be created and instantiated within the UEFD during continued operation of the UEFD. The method can further include the steps of defining a filter algorithm text string, incorporating the filter algorithm text string into a filter class template, and compiling the filter class template to create the filter object. The filter algorithm can be simple or complex. A preexisting filter object can be de-referenced immediately prior to instantiating the filter object. Provisions can be incorporated for automatically checking type and syntax of the filter algorithm text string to identify one or more errors and providing an output error signal in the case that the one or more errors are identified. The UEFD can incorporate multiple filter parameters. A method for managing at least one event forwarding discriminator is provided. A filter algorithm can be received via SNMP or other management protocols from a subscriber and used to create a filter object, an event forwarding discriminator shell can be created, and the filter object can be instantiated within the event forwarding shell to create a UEFD. The UEFD can have an identification relating the UEFD to the subscriber. The subscriber can then update the UEFD when desired.

### BACKGROUND OF THE INVENTION

1.Technical Field

The invention relates generally to data communications networks. More particularly, the invention relates to implementation of filter parameters in event forwarding discriminators.

2. Description of the Related Art

Modern day data communications networks include multiple network elements, for example, base stations and repeaters. Network elements can be quite sophisticated and are often installed in remote locations. These network elements, and their components, provide network resources to data communications networks. A network management system is typically used to manage the network resources within the network. A computer interface is typically provided within network elements to enable the management system to communicate with, and manage, the network resources.

A typical network management system can incorporate Simple Network Management Protocol (SNMP). SNMP has two components; an agent and a manager. Within a managed system there is an SNMP agent (agent) on each network element. There is usually only a single SNMP manager (manager) that supervises all of the agents in a system. SNMP has two basic functions that a manager may perform; SET and GET. SET permits the manager to change variables on the agent. GET provides the manager with the capability to query any agent for its variables' values. Passing an asynchronous notification to a manager is the only autonomous (non solicited) function that an agent may perform.

Notifications are information emitted from “managed objects” upon an occurrence of an event. Managed objects are essentially data definitions representing resources within a particular network element. For example, a managed object can represent a hardware unit, or a software resource that has no physical representation. Notably, managed objects have attributes, which are associated values that can determine or reflect the behavior of the resource being represented. A management information base (MIB) 105 residing in the network element stores the managed object data definitions. Hence, a manager and an agent can communicate with the managed objects contained in the MIB 105, not the actual data network resources.

Event filtration can be incorporated onto a network element to control when notifications received from managed objects are sent to the agent for forwarding to the Manager. An Event Forwarding Discriminator (EFD) is an exemplary object that can filter the notifications. An EFD is a special type of managed object that is in the discriminator object class defined by Recommendation X.734 of The International Telegraph and Telephone Consultative Committee. CCITT Rec. X.734 (1992 E), ISO/IEC 10164-5: 1993 (E). An EFD receives notifications communicated by other managed objects and selectively forwards these notifications to the agent. The EFD contains a discriminator construct, referred to in the art as a “filter”, which evaluates the notifications based on pre-determined filter algorithms using event variables and operators to determine which notifications are to be forwarded to the agent and when to forward them. The filtered notifications are referred to in the art as “event reports”. The object variables and operators that the EFD uses are defined for the EFD in the MIB 105, which must be compiled prior to activation of a network element. Hence the event variables and operators must be defined prior to system activation.

The operational states defined for the EFD are enabled and disabled. The enabled state is the state in which the EFD is operational and can process notifications received from managed objects, unless the EFD is administratively prohibited from doing so or is scheduled “off-duty”. In the disabled state the EFD is inoperable and does not process any notifications.

The administrative states for an EFD are unlocked and locked. In the unlocked state and when the operational state is enabled, the EFD can process notifications received from managed objects. In the locked state, event forwarding is suspended by the management application.

CCITT Rec. X.734, §8.1.1.2 suggests that multiple logical operators, such as “AND” and “OR” can be applied in filters to test multiple assertions, such as equality and inequality conditions. Filters testing multiple assertions, as well as those applying nested filter operations, are referred to in the art as complex filters. Currently, complex filters need to be determined before an EFD is compiled because assertions cannot be logically combined or nested by merely changing filter states. Not only is it difficult to anticipate all logical combinations or nested structures that may be required, but providing an EFD with a large number of assertion combinations (constructs) results in a large and inefficient EFD. Downloading such an EFD to a remote site could take a long time, especially if a slow download connection is utilized. Further, each time a notification is received by such an EFD, it can take a long time to process because the EFD necessarily checks the notification against all of the filter constructs provided in order to process the notification. Thus, only complex filters that have anticipated use are programmed into EFD's.

If a previously unanticipated complex filter is required, the EFD software process is typically halted while a new EFD executable is compiled. The new EFD must then be activated to restart the EFD process. The time lapse between when the EFD process is halted and when the EFD process is restarted can take several seconds, during which any events that are sent to the EFD are lost and unrecoverable. This is a particular problem in real time communication systems where clients will not accept lost data.

Runtime linguistic reflection gives a programming system the ability to incorporate new program fragments into the ongoing computation. Runtime is when a program is running or being executed. When a program is running on a computer, it is runtime for that program. In runtime linguistic reflection, the executing program generates new program fragments in the form of source code, invokes a dynamically callable compiler, and finally links the results of the compilation into its own execution. This has several applications in a persistent environment including supporting safe evolution of long-lived programs and data, and specifying highly generic programs that may be reused in many contexts. The linguistic reflection process can also include a process for checking of the generated program fragments to ensure type safety.

Forms of linguistic reflection are provided in JAVA and other object-oriented languages. Linguistic reflection in some of these languages involves the execution of generator procedures, which produce as their results representations of program fragments in the corresponding language. These program fragments can be dynamically compiled after appropriate validity checks and the program fragments can be incorporated into an application at run time. In JAVA, for example, an interface can be used to invoke a JAVA compiler dynamically from a running Java program.

Class loaders are a mechanism that can be used for dynamically loading and unloading compiled program fragments at runtime. Class loaders perform two functions. First, a class loader finds the code. Each class loader can use its own method for finding requested code files. For example, it can load them from the local disk, fetch them across the Net using any protocol, or it can create the code. Second, class loaders define the namespaces seen by different classes and how those namespaces relate to each other. A namespace is a set of unique names of classes loaded by a particular class loader and a binding of each name to a specific class object.

Hence, what is needed is a method for applying complex filter constructs to an EFD, for example using linguistic reflection and class loaders, while only momentarily interrupting EFD processing, without loss of data.

### SUMMARY OF THE INVENTION

The invention disclosed herein provides an updateable event forwarding discriminator that can be dynamically updated with a filter and a method for dynamically updating a filter in an updateable event forwarding discriminator (UEFD) during continued operation of the UEFD. More specifically, the invention provides that a filter algorithm can be generated and compiled to create a filter object (filter) that can be instantiated within the UEFD during continued operation of the UEFD. A filter can also be de-referenced during operation of the UEFD. Notably, because the UEFD can be updated without being halted, the update process can occur without event data loss.

One aspect of the invention can include a method for updating an event forwarding discriminator with a filter object. The filter object can be created and instantiated within the UEFD during continued operation of the UEFD. The method can further include the steps of defining a filter algorithm text string, incorporating the filter algorithm text string into a filter class template, and compiling the filter class template to create the filter object. The filter algorithm can be simple or complex. A preexisting filter object can be de-referenced immediately prior to instantiating the filter object. Provisions can be incorporated for automatically checking type and syntax of the filter algorithm text string to identify one or more errors and providing an output error signal in the case that the one or more errors are identified.

Another aspect of the invention is a UEFD that includes a modifiable filter parameter, wherein the modifiable filter parameter includes at least one individually compiled filter object. The filter object can be compiled from a filter class template incorporating a filter algorithm. The filter object can instantiate within the UEFD during continued operation of the event forwarding discriminator. A preexisting filter object can be de-referenced during continued operation of the UEFD. Further, a pre-existing filter can be de-referenced immediately prior to a filter object instantiating within the UEFD.

In yet another aspect of the invention, a method for managing at least one event forwarding discriminator is provided. A filter algorithm can be received from a subscriber and used to create a filter object, an event forwarding discriminator shell can be created, and the filter object can be instantiated within the event forwarding shell to create a UEFD. The UEFD can have an identification relating the UEFD to the subscriber. The subscriber can then update the UEFD when desired.

### BRIEF DESCRIPTION OF THE DRAWINGS

There are presently shown in the drawings embodiments which are presently preferred, it being understood, however, that the invention is not limited to the precise arrangements and instrumentalities shown.

FIG. 1 shows a simplified block diagram of network elements contained in a data communications network.

FIG. 2 shows a flow chart for updating an updateable event forwarding discriminator according to an embodiment of the invention.

FIG. 3A shows a simplified block diagram of an updateable event forwarding discriminator immediately before being updated.

FIG. 3B shows a simplified block diagram of an updateable event forwarding discriminator immediately after being updated.

FIG. 4 shows a simplified block diagram of a system incorporating a network element that includes multiple updateable event forwarding discriminators.

FIG. 5 shows a flow chart for creating and updating multiple updateable event forwarding discriminators.

### DETAILED DESCRIPTION OF THE PREFERRED EMBODIMENTS

The invention disclosed herein provides an updateable event forwarding discriminator that can be dynamically updated with a filter and a method for dynamically updating a filter in an updateable event forwarding discriminator (UEFD) during continued operation of the UEFD. More specifically, the invention provides a filter algorithm that can be generated and compiled to create a filter object (filter) that can be instantiated within the UEFD during continued operation of the UEFD. A filter can also be de-referenced during operation of the UEFD. Notably, because the UEFD can be updated without being halted, the update process is synchronous thereby insuring any events sent to the UEFD are buffered and not lost.

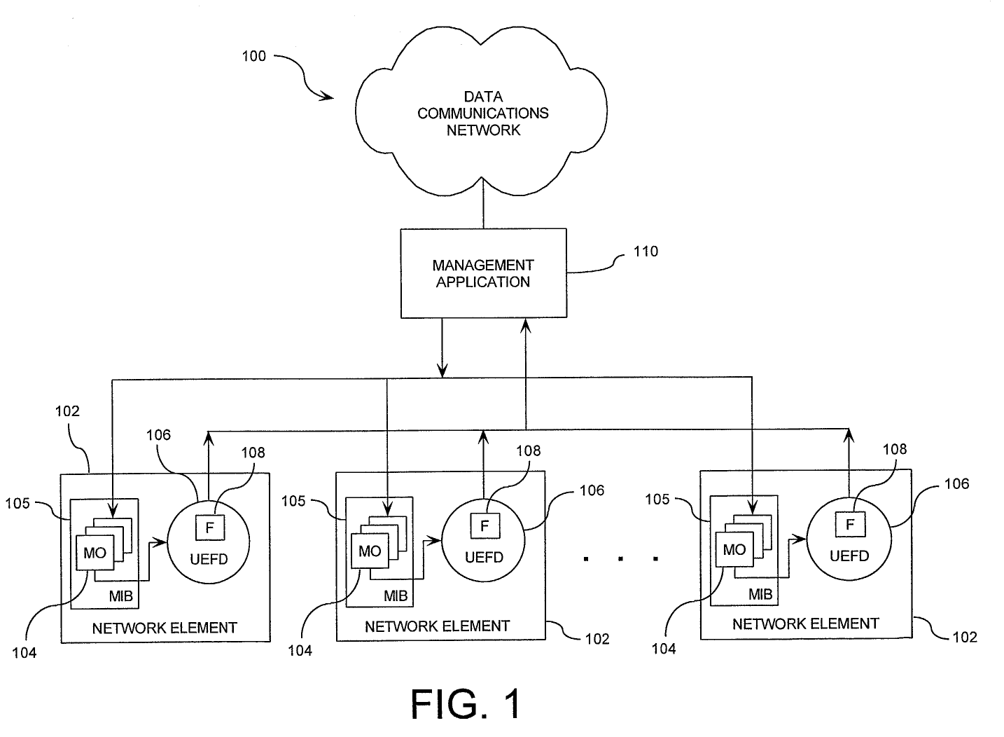

FIG. 1 shows a simplified block diagram of network elements 102 contained in a data communications network 100. The term data communications network is herein interpreted broadly and encompasses any network of devices wherein data is communicated. A data communications network can include, but is not limited to, computer networks, telephone networks, mobile communications networks, video networks, satellite networks, etc.

Network elements 102 can be any elements in a data communications network 100 that provide network resources. For example, a network element 102 can be a wireless base station or a repeater, but is not thus limited. A management application 110 is software that runs on a computer, or multiple computers, that is typically provided to manage network resources. Management applications typically incorporate some form of network protocol. For example, Simple Network Management Protocol (SNMP) is often used. However, the invention is not thus limited and other network protocols can be used.

Managed objects 104 are abstractions of one or several network resources, which can be either physical or logical. Managed objects are essentially data definitions representing resources within a particular network element. For example, a managed object 104 can represent a hardware unit, or a software resource that has no physical representation. Notably, managed objects have attributes, which are associated values that can determine or reflect the behavior of the resource being represented. A management information base (MIB) 105 residing in the network element stores the managed object data definitions. Hence, management application 110 can communicate with the managed objects 104 contained in the MIB 105, not the actual data network resources.

UEFD 106 is an updateable event forwarding discriminator that can be dynamically updated with a simple or complex filter 108 during continuous operation of UEFD 106. As previously discussed, an event forwarding discriminator is a special type of managed object that is in the discriminator object class. An EFD receives notifications communicated by other managed objects and selectively forwards these notifications to the management application. The EFD contains a filter that acts on the notifications to control what types of notifications should be forwarded to the management application as event reports. Once EFDs are established on each network element being monitored, the management application can wait for unsolicited event reports to arrive.

Each EFD has an operational state and an administrative state. The operational states defined for the EFD are enabled and disabled. The enabled state is the state in which the EFD is operational and can process notifications received from managed objects, unless the EFD is administratively prohibited from doing so or is scheduled “off-duty”. In the disabled state the EFD is inoperable and does not process any notifications.

The administrative states for an EFD are unlocked and locked. In the unlocked state the EFD can process notifications received from managed objects. In the locked state, EFD processing of the notifications is prohibited by the management application.

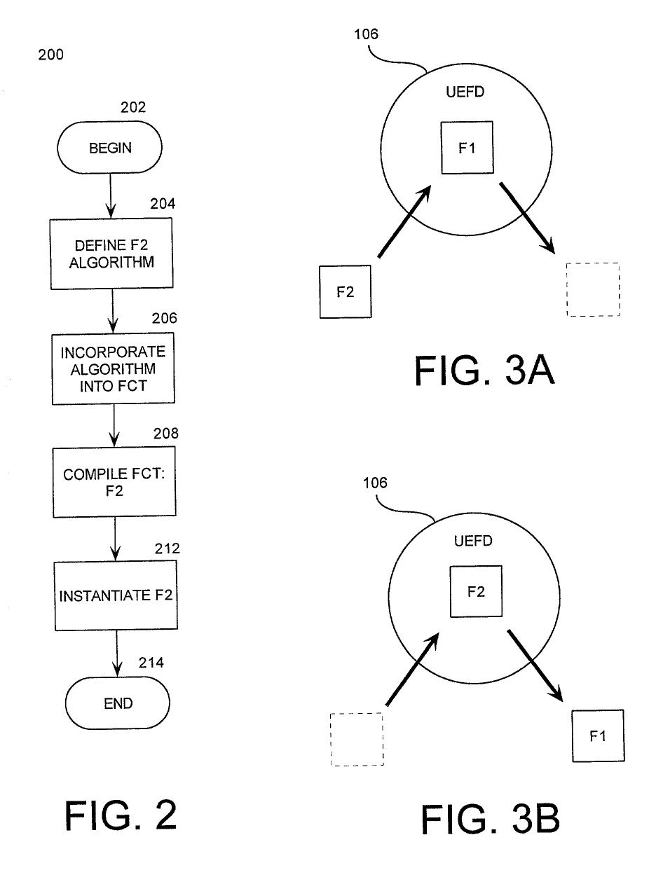

Referring to FIG. 2, a flow chart 200 shows the steps for updating UEFD 106 according to an embodiment of the invention. The process for updating the UEFD begins at step 202. Referring to step 204, a filter algorithm can be defined for a new filter to be created, F2. The filter algorithm can be simple or complex and can be generated as an ASCII text string or using any other computer recognizable programming language consistent with the language being used for UEFDs.

In one embodiment, a user can use a graphical user interface operating on a computer (user computer) in a location remote to network element 102 to define the filter algorithm in a graphical form. A computer application can be provided on the user computer to translate the filter algorithm from graphical form into an alternate machine-readable form. For example, the computer application can translate the filter algorithm from graphical form into an ASCII text string. The ASCII text string can be forwarded to the management application using an SNMP set command, which can then forward it to the appropriate network element; or, the ASCII text string can be directly forwarded to the network element.

A source language compiler can automatically check the type and syntax of the filter algorithm on the server where the management application 110 is located. This function can also operate on the user computer to accelerate debugging of the algorithm. For example, linguistic reflection can operate on a system with the management application to provide the appropriate validity checks. Errors found can be identified and at least one error signal can be generated. The error signal can be output to a user interface on the user computer. For example, a message can be generated that lists the errors found and the location of the errors. This message can be forwarded to a display, printer, audio transducer, or to some other user interface.

Referring to step 206, the management application 110 can utilize linguistic reflection to incorporate the filter algorithm into a filter class template (FCT) to create the computer code necessary to create a filter class object. The FCT can be a filter object code template containing code in the header and a footer of the template, which is essentially all of the computer code necessary to generate a filter object less the filter algorithm. Hence, only filter algorithm code needs to be generated to create a new filter class object.

Using linguistic reflection, the management application 110 can invoke a dynamically callable compiler to compile the FCT incorporating the filter algorithm code to create the new filter object, F2, as shown in step 208. Dynamic compilation of the FCT can typically take place on a network element 102 where an original FCT can be stored. Alternatively, dynamic compilation of the FCT can take place on the system where the management application is stored. When a new FCT is required, for example when a new filter object needs to be created, the code from the original FCT can be copied to create a new FCT. This leaves the original FCT available on the network element 102 for further use in creating new filter objects.

Referring to FIG. 3A, F1 is a filter object currently operating within UEFD 106. Referring back to step 212 of FIG. 2, a class loader can instantiate F2 within UEFD 106 while UEFD continues to operate. Instantiating F2 within UEFD effectively de-references F1, which can occur immediately prior to F2 being instantiated. The process of de-referencing of F1 and instantiating F2 happens very quickly and is synchronous so that UEFD does not miss any notifications generated by managed objects. FIG. 3B illustrates UEFD 106 after F1 has been de-referenced and F2 has been instantiated. JVM Dynamic Class Loading is available in JAVA and is an example of a form of class loading that can be used, but the invention is not thus limited and other class loading techniques can be used.

In some network management applications, such as SNMP, a manager can dynamically update a UEFD 106. In such a system the manager is defined as a subscriber, although a subscriber can also be a computer program or user, for example. A filter algorithm can be passed from the manager to an agent and stored as a MIB string in a filter update variable. When a SET command is received for the filter update variable from the manager, the variable can be incorporated into an FCT, the filter class object code can be compiled, and the new filter object created can be instantiated in a UEFD. Currently, SNMP MIB string variables can be up to 65,535 bytes in length, providing the capability for a very complex filter algorithm to be defined.

Although an EFD can be a stand-alone object communicating with an agent, an EFD server can be used as a server object to implement multiple UEFDs 106 on a network element and to provide a link between subscribers and the UEFDs. In this embodiment filter objects can be dynamically instantiated and de-referenced as required. For example, a first UEFD can be updated with a new filter object while other UEFDs continue to operate.

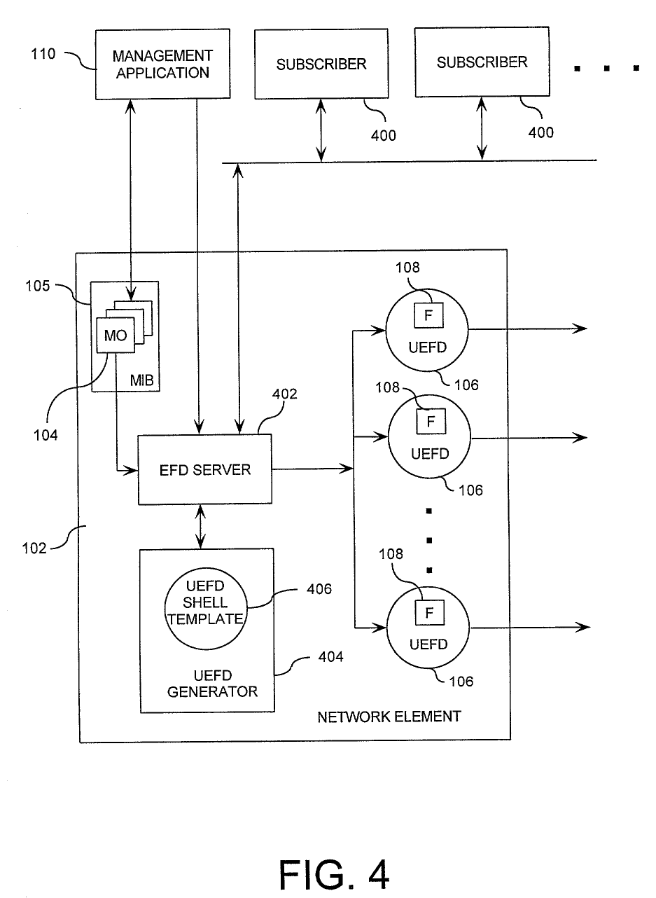

Referring to FIG. 4, an EFD server 402 in a data communications network is shown. The EFD server 402 can be located on a network element, on a subscriber's computer system or remote to a subscriber's computer system. Subscribers 400 can communicate directly with the EFD server 402 if the EFD server is on the subscriber's computer system, or via the data communications network if the EFD server is remote to the subscriber's computer system. Management application 110 can communicate with the EFD server 402 directly or via the data communications network as well.

The EFD server 402 can manage multiple UEFDs 106 on a network element 102. Typically, only one MIB 105 is required on the network element to store the managed object data definitions. EFD server 402 can communicate with a UEFD generator 404 to generate UEFD shells from UEFD shell template 406. A UEFD shell is a UEFD 106 without a filter 108. The UEFD generator 404 can be a software application and can be stored at the same location as the EFD server 402, for example on the network element 102.

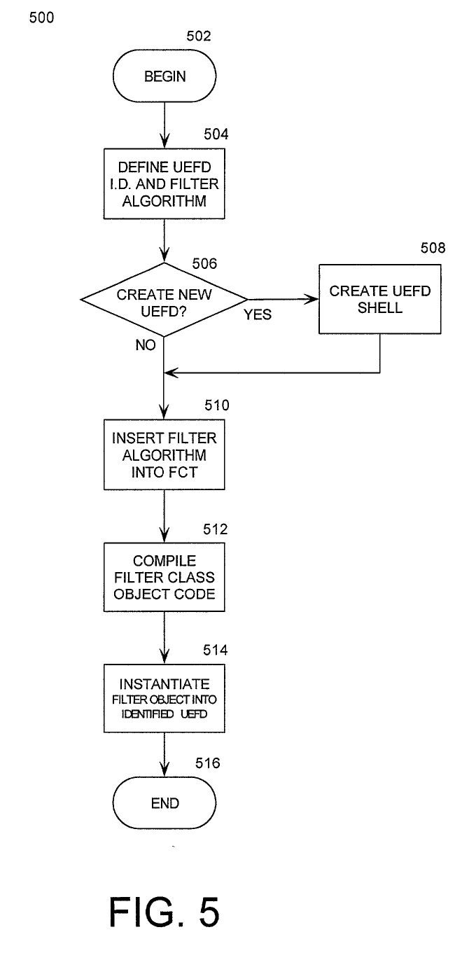

Referring FIG. 5, the process for updating a first UEFD begins at step 502 of the flowchart 500. One or more subscribers 400 can register with an EFD server 402 on a particular network element 102 by defining a UEFD identification and a filter algorithm, as shown in step 504. The filter algorithm can be defined as a string variable or other code consistent with the language of the UEFDs. The UEFD identification can identify a pre-existing UEFD where the filter object 108 needs to be replaced with a new filter object created from the filter algorithm, or the UEFD identification can direct that a new UEFD be created, wherein a filter object created with the filter algorithm can be instantiated and a UEFD identification returned to the subscriber 400 for future reference.

As shown in decision block 506, the UEFD identification can direct that a new UEFD be created. The EFD server 402 can then direct a UEFD generator 404, which is an object that creates UEFD shells, to create a new UEFD shell, as shown in step 508. Essentially, a UEFD shell is a UEFD less the filter object. The UEFD shell can be created by compiling code copied from a UEFD shell template 406. Alternatively, the UEFD identification can identify an existing UEFD 106 to be updated. In this case a UEFD shell is not created and the EFD server 402 merely updates the identified UEFD 106 with a new filter 108.

The EFD server 402 can insert the filter algorithm into an FCT to create code for a filter class object, as shown in step 510, and dynamically compile the filter class object code to create a filter object, as shown in step 512. Referring to step 514, the resulting filter object can then be instantiated into the identified UEFD 106 or the newly created UEFD shell in the same manner described above, for example using linguistic reflection and class loaders.

Once the subscriber's filter algorithm is instantiated in a UEFD 106 identified by the subscriber 400, the EFD server 402 can then forward the relevant event reports to the identified UEFD 106, which then uses the filter 108 to determine if the event report should be forwarded to the subscriber 400. In one embodiment the UEFD 106 can create a report forwarding object for each event report to handle the task of forwarding event report. This can allow the UEFD 106 to continue evaluating event reports sent to it by the EFD Server 402 while the report forwarding objects handle processing for forwarding the event reports to the subscribers. Because the subscriber's UEFD is identified, the subscriber can update the UEFD when desired.

Another feature of the present invention is that the UEFDs can be persistently stored (persisted) into an EFD table or a datastore. If for any reason the EFD server were to abnormally terminate, it would not be necessary for each subscriber to re-subscribe with the EFD server. When the EFD server starts, it can check to see if there are UEFDs in the EFD table and who is subscribing to them. If there are UEFDs in the datastore, the EFD server can re-create the UEFDs from the datastore and the re-created UEFDs can immediately begin forwarding events to their respective subscribers. This action may occur quickly enough that the subscriber 400 never realizes that it's UEFD has failed and restarted.

Safety protocols can be implemented on UEFDs and other objects so that a program or management application cannot perform an operation on an object unless that operation is valid for that particular object. For example, a safety protocol can be implemented to prevent an UEFD shell from being compiled without incorporation of a filter object. One safety protocol that can be used is type safety, which is used in the JAVA programming language. Further, subscribers, which can be programmers, can have complete control over dynamic class loading, identifying which filter objects to load during runtime operation. Further, filter update access can be restricted to the filter creator, thereby insuring that the UEFDs cannot be updated by unauthorized parties.

It should be understood that the examples and embodiments described herein are for illustrative purposes only and that various modifications or changes in light thereof will be suggested to persons skilled in the art and are to be included within the spirit and purview of this application. The invention can take many other specific forms without departing from the spirit or essential attributes thereof for an indication of the scope of the invention.

1. A method for updating an event forwarding discriminator, comprising:
creating a filter object; and,
instantiating said filter object within the event forwarding discriminator during continued operation of the event forwarding discriminator.

2. The method of claim 1, wherein said creating a filter object comprises:
defining a filter algorithm text string;
incorporating said filter algorithm text string into a filter class template; and,
compiling said filter class template.

3. The method of claim 2, further comprising:
automatically checking type and syntax of said filter algorithm text string to identify one or more errors; and,
providing an output error signal in the case that said one or more errors are identified.

4. The method of claim 1, wherein said filter object comprises a complex filter algorithm.

5. The method of claim 1, wherein a preexisting filter object is de-referenced immediately prior to instantiating said filter object.

6. The method of claim 1, further comprising persisting said event forwarding discriminator to a datastore.

7. A method for creating an event forwarding discriminator, comprising:
creating an event forwarding discriminator shell;
creating a filter object; and,
instantiating said filter object within said event forwarding discriminator shell.

8. The method of claim 7, wherein said creating a filter object comprises:
defining a filter algorithm;
incorporating said filter algorithm into a filter class template; and,
compiling said filter class template.

9. The method of claim 8, further comprising:
automatically checking type and syntax of said filter algorithm to identify one or more errors; and,
providing an output error signal in the case that said one or more errors are identified.

10. The method of claim 7, wherein said filter object comprises a complex filter algorithm.

11. The method of claim 7, wherein said event forwarding discriminator comprises a subscriber identification.

12. The method of claim 7, further comprising persisting said event forwarding discriminator to a datastore.

13. A method for managing at least one event forwarding discriminator, comprising:
receiving a filter algorithm from a subscriber;
creating an event forwarding discriminator shell;
creating a filter object from said filter algorithm; and,
instantiating said filter object within said event forwarding discriminator shell to create an event forwarding discriminator.

14. The method of claim 13, further comprising:
receiving from said subscriber a new filter algorithm;
creating a new filter object from said new filter algorithm; and,
instantiating said new filter object within said event forwarding discriminator during continued operation of said event forwarding discriminator.

15. The method of claim 13, wherein said creating a filter object from said filter algorithm comprises:
incorporating said filter algorithm into a filter class template; and,
compiling said filter class template.

16. The method of claim 13, further comprising:
automatically checking type and syntax of said filter algorithm to identify one or more errors; and,
providing an output error signal in the case that said one or more errors are identified.

17. The method of claim 13, wherein said filter object comprises a complex filter algorithm.

18. The method of claim 13, wherein said event forwarding discriminator comprises a subscriber identification.

19. The method of claim 14, wherein said filter object is de-referenced immediately prior to instantiating said new filter object.

20. The method of claim 13, further comprising persisting said event forwarding discriminator to a datastore.

21. An event forwarding discriminator comprising at least one modifiable filter parameter, wherein said at least one modifiable filter parameter comprises at least one individually compiled filter object.

22. The event forwarding discriminator of claim 21, wherein said at least one filter object is compiled from a filter class template incorporating a filter algorithm.

23. The event forwarding discriminator of claim 21, wherein said at least one filter object instantiates within said event forwarding discriminator during continued operation of said event forwarding discriminator.

24. The event forwarding discriminator of claim 21, wherein said event forwarding discriminator de-references a pre-existing filter object immediately prior to said at least one filter object instantiating within said event forwarding discriminator.

25. The event forwarding discriminator of claim 21, further comprising:
a filter algorithm type and syntax verification; and,
an error signal generator that generates an error when one or more errors are identified by said type and syntax verification.

26. In a network management system, a method for dynamically updating a filter in an event forwarding discriminator during runtime of said network management system, comprising:
defining an updated filter algorithm;
inserting said updated filter algorithm in a filter class computer code template (FCT) to produce an updated filter class computer code;
compiling during runtime said updated filter class computer code to produce an updated filter class object;
communicating during runtime at least one of said updated filter class computer code and said updated filter class object from a network manager application to an agent application for a managed network element;
responsive to a control notification from said network manager application, dynamically instantiating said updated filter class object in an updateable event forwarding discriminator (UEFD) of said agent application during runtime of said UEFD.

27. The method according to claim 26 further comprising verifying that a particular user is an owner of the event forwarding discriminator being updated.

28. The method according to claim 26 further comprising de-referencing an existing filter class object and dynamically instantiating said updated filter class object as a substitute therfor.

29. The method according to claim 26 wherein said compiling step further comprises invoking a dynamically callable compiler.

30. The method according to claim 26 wherein said instantiating step is performed using a class loader.

31. The method according to claim 26 wherein said agent application resides on said managed network element.

32. The method according to claim 26 wherein said agent is an event forwarding discriminator (EFD) server application.

33. The method according to claim 32 further comprising:
responsive to a subscriber a notification, dynamically creating a new UEFD into which said updated filter class object is to be instantiated.

34. The method according to claim 33 wherein said UEFD shell is dynamically compiled from a UEFD shell template.

35. The method according to claim 33 further comprising storing said UEFD in a persisted UEFD data store and re-creating said UEFD from the UEFD datastore subsequent to an abnormal termination of said EFD server application.
